(19) United States
(12) Patent Application Publication
(10) Pub. No.: US 2020/0284187 A1
(43) Pub. Date: Sep. 10, 2020

(54) Twin Scroll Turbocharger with Waste Heat Recovery

(71) Applicant: Edward Charles Mendler, Mill Valley, CA (US)

(72) Inventor: Edward Charles Mendler, Mill Valley, CA (US)

(21) Appl. No.: 15/933,000

(22) PCT Filed: Dec. 6, 2016
(86) PCT No.: PCT/US16/00116

§ 371 Date: Jun. 7, 2018

Related U.S. Application Data
(60) Provisional application No. 62/386,901, filed on Dec. 14, 2015.
(60) Provisional application No. 62/391,136, filed on Apr. 19, 2016.
(60) Provisional application No. 62/493,881, filed on Jul. 18, 2016.

(51) Int. Cl. F02B 37/16; F01N 3/10; F02D 23/02

(52) U.S. Cl. CPC F02B 37/162; F02D 23/02; F01N 3/10

(57) ABSTRACT

Bypass air from downstream of the compressor is directed into a heat exchanger that draws heat from the exhaust gas of the engine. The bypass air does not include fuel, and instead is heated by the exhaust gas in the heat exchanger. The bypass duct enables air mass flow through the compressor to be increased, thereby preventing compressor surge at low engine speeds. The turbocharger turbine includes a dual entry scroll. The bypass air is fed into the first scroll after being heated in the heat exchanger, and the engine' exhaust gas is fed into the second scroll. Use of two scrolls enables the blowdown impulse energy of the exhaust gas to be retained within the exhaust manifold prior to entry into the turbine, thereby providing improved turbocharger response and preventing backflow of exhaust gas into the bypass duct. Using the exhaust energy to heat the bypass air instead of combusting additional fuel leads to increased engine efficiency.

This application relates to Provisional Application No. 62/386,901 having a filing date of Dec. 14, 2015, Provisional Application No. 62/391,136 having a filing date of Apr. 19, 2016 and Provisional Application No. 62/493,881 having a filing date of Jul. 18, 2016.

### BACKGROUND OF THE INVENTION

Engine downsizing is viewed by US and foreign automobile manufacturers as one of the best options for improving passenger car and light duty truck fuel economy. While this strategy has already demonstrated a degree of success, downsizing and fuel economy gains are currently limited by the ability of low-cost turbocharging systems to provide high boost pressures over a wide range of engine speeds.

At low engine speeds turbochargers are generally unable to deliver high boost pressures because of surge and insufficient turbine power. When boost pressures become too great the inertial force of the air exiting the compressor is overcome by the high pressure air downstream. When this occurs the pressurized air downstream of the compressor surges back upstream through the compressor. The compressor inducer first stalls, and then pressurized downstream air surges upstream.

The boost pressures that can be sustained without encountering surge decrease as engine speed decreases, because the air mass flow volume and therefor air speed through the compressor also decreases. The lower speed air is less able to hold back the pressurized air downstream of the compressor.

A smaller turbocharger can be used for attaining higher boost pressures at low engine speed, because the smaller turbocharger has a smaller outlet area and a higher air flow velocity. The turbine must also produce enough power from the exhaust gas to drive the compressor. A smaller turbine can produce more shaft power from the smaller flow of exhaust gas at low engine speeds, the increased shaft power being needed to produce higher boost pressures with or without surge. The problem with using a smaller turbocharger, however, is that maximum engine power is reduced. If maximum power is reduced, the fuel economy benefits from engine downsizing cannot be attained.

A number of technologies can provide higher boost pressures at low engine speeds, however those technologies are expensive. Technologies that provide high boost pressure over a wide range of engine speeds but that are relatively expensive include combining turbo and supercharging; electrically driven turbochargers; variable geometry turbochargers and sequential turbocharging.

Dual scroll or twin scroll turbochargers are beneficial but do not provide a large enough gain to meet future engine needs. The dual scroll when applied to cylinder engines. The first benefit is separating the combustion pulses between the cylinders. The second benefit is a smaller exhaust manifold volumes upstream of the turbine. The smaller manifold volume increases the impulse blow down energy of the exhaust gas entering the turbine, leading to improved turbocharger response at low engine speeds.

Some gain in boost pressure can be realized by routing exhaust from all of the cylinders into both of the scrolls of a twin scroll turbine at high engine speeds, and then closing off one of the scrolls to attain higher boost pressure at low engine speeds. This approach has limited benefit.

Anti-lag system technology commonly referred to as ALS is another approach used for attaining high boost pressures over a broad range of speeds. The anti-lag system technology includes a bypass duct for routing compressed air from downstream of the compressor into the exhaust manifold upstream of the turbine. The engine is run with a rich fuel air mixture ratio, and the excess fuel explodes in the exhaust manifold upstream of the turbine on contact with the bypass air. The technology has a number of problems when considered for passenger cars and light duty trucks, including noise, emissions compliance and reduced turbocharger life. The exploding gas can also blow back through the bypass duct into the engine air intake system.

The AMX Leclerc French main battle tank employs another approach. The AMX Leclerc has an 8-cylinder 1500 horse power hyperbar diesel engine. The hyperbar system integrates a Turbomeca TM 307B gas turbine in the engine, acting both as a turbocharger and an auxiliary power unit. A fuel and air mixture is combusted in a combustor upstream of the turbine to increase turbine power output. Employing a gas turbine combustor in a passenger car or light duty truck would be prohibitively expensive, and introduce safety concerns.

Accordingly, an objectives of the current invention is to provide a low cost turbocharging system capable of providing high boost pressures over a wide range of engine speeds. Another objective is to meet safety needs for commercial use of the technology in passenger cars and light duty trucks. Another objective is for the turbocharging system to have a high efficiency in order to maximize vehicle fuel economy. Yet another objective is to minimize exhaust gas emissions from engines employing the turbocharging technology.

### SUMMARY OF THE INVENTION

According to the present invention, bypass air from downstream of the compressor is directed into a heat exchanger that draws heat from the exhaust gas of the engine. The bypass air does not include fuel, and instead is heated by the exhaust gas in the heat exchanger. The bypass duct enables air mass flow through the compressor to be increased, thereby preventing compressor surge at low engine speeds. The turbocharge [symbol] entry scroll. The [symbol] ss air is fed into the first scroll after being heated in the heat exchanger, and the engine exhaust gas is fed into the second scroll. Both turbine scrolls are used at low engine speeds for maximizing engine torque. Use of two scrolls enables the blowdown impulse energy of the exhaust gas to be retained within the exhaust manifold prior to entry into the turbine. In more detail the exhaust gas does not backflow into the bypass duct and loose working pressure. Engine efficiency is also increased by using the exhaust energy to heat the bypass air instead of combusting additional fuel. There is no explosive combustion of fuel and bypass air upstream of the turbine that would create noise and decrease turbocharger life. The heated bypass air flowing into the turbine increases turbine power leading to higher turbocharger boost pressure ratios.

A control valve may optionally be used to open both scrolls for exhaust flow, and close of the bypass duct at high engine speeds where use of the bypass duct is not needed. Flow of exhaust gas into both of the scrolls at high engine speeds enables higher maximum engine power output levels to be attained. In more detail, the first scroll is used for the bypass air during low speed engine operation, and the second scroll is used for exhaust gas at all engine speeds. Use of separate scrolls for the bypass air and exhaust gas prevents exhaust pressure waves from propagating into the bypass duct and Intake air system of the engine. At high engine speeds the first scroll or bypass scroll may be closed. Optionally the bypass scroll may be unused during high engine speeds, or a valve may be used to open the bypass scroll for receiving exhaust gas so that both the first and second scroll receive exhaust gas during high speed engine operation. Use of both scrolls for exhaust gas enables higher engine power levels to be achieved.

The present invention enables high boost pressures to be attained across a wide range of engine speeds. Yet another advantage of the present invention is that it does not include a combustor or a secondary fuel delivery system. The fueling needs can be fully met with the existing fuel injection system. A significant advantage of the present invention is that use of waste heat recovery through the exhaust gas heat exchanger provides improved engine efficiency relative to other engines operating at similar speed and brake mean effective pressure. Another advantage of the present invention is that the heated bypass air and exhaust gas from the engine enter the turbine through separate scrolls. Use of separate scrolls prevents the exhaust gas from back flowing into the bypass duct. Another advantage of the turbocharging system is that it has a relatively low cost. An expensive heat exchanger is not required for effective operation of the turbocharger system. High boost pressures can be attained with the present invention across a wide engine speed range. Prospective applications for the technology include long haul diesel trucks where steady state fuel economy can be improved through the waste heat recovery, and light duty cars and trucks where fuel economy can be significantly improved [symbol] zing.

In current production engines it is common to employ a rich fuel to air mixture during high load engine operating conditions in order to internally cool the engine and suppress detonation. According to an embodiment of the present invention, under high loads the fuel injection system of the engine injects excess fuel for combustion. Enrichment levels are similar to current production engines. The unburned excess fuel in the exhaust gas combines with the bypass air and undergoes catalytic combustion in the catalytic converter. The catalytic combustion increases the temperature of the exhaust gas entering the heat exchanger, causing the temperature of the bypass air entering the turbine to become even hotter. The increase of bypass air temperature increases the power output of the turbine causing the compressor to spin faster and generate higher boost pressures. In addition to increasing turbocharger boost pressure, hydrocarbon emissions are reduced because the added air provides the needed oxygen for complete combustion of the fuel. The turbine is upstream and isolated from the catalytic combustion. Effective waste heat recovery in the heat exchanger minimizes the degree and frequency of enrichment.

Advantages of the present invention include increased boost pressure at low engine speeds without compromising maximum engine power output; increased engine efficiency at some engine power levels due to the waste heat recovery of the heat exchanger; lower hydrocarbon emissions during high load conditions due to bypass air being provided for complete combustion of the fuel during rich engine operating conditions; and a relatively low cost.

### BRIEF DESCRIPTION OF THE FIGURES

FIG. 1 is intended to diagrammatically illustrate air flow through a turbocharger compressor according to the present invention, and in more detail FIG. 1 is intended to diagrammatically illustrate a portion of the present invention.

FIG. 2 is intended to diagrammatically illustrate an extended performance range turbocharging system according to the present invention.

FIG. 3 is similar to FIG. 2 but includes a turbine entry valve.

FIG. 4 is similar to FIG. 3 but shows turbine entry valve with a different setting.

FIG. 5 is similar to FIG. 2 but shows a single entry turbine scroll.

FIG. 6 is similar to FIG. 5 but has a rich fuel to air ratio.

FIG. 7 is a section view of a twin scroll turbocharger having a turbine clearance volume.

FIG. 8 is similar to FIG. 3 but without a heat exchanger.

FIG. 9 is similar to FIG. 4 but without a heat exchanger.

### DETAILED DESCRIPTION OF THE PREFERRED EMBODIMENTS

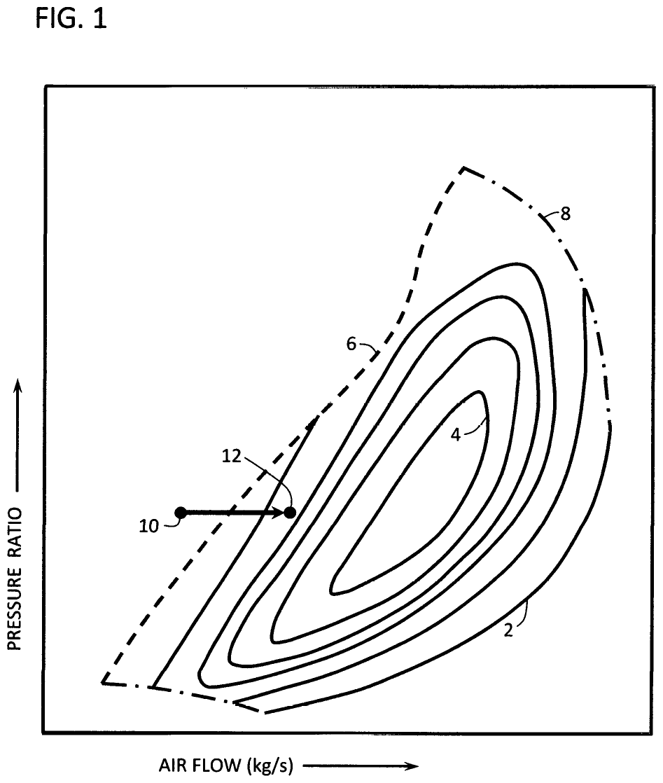

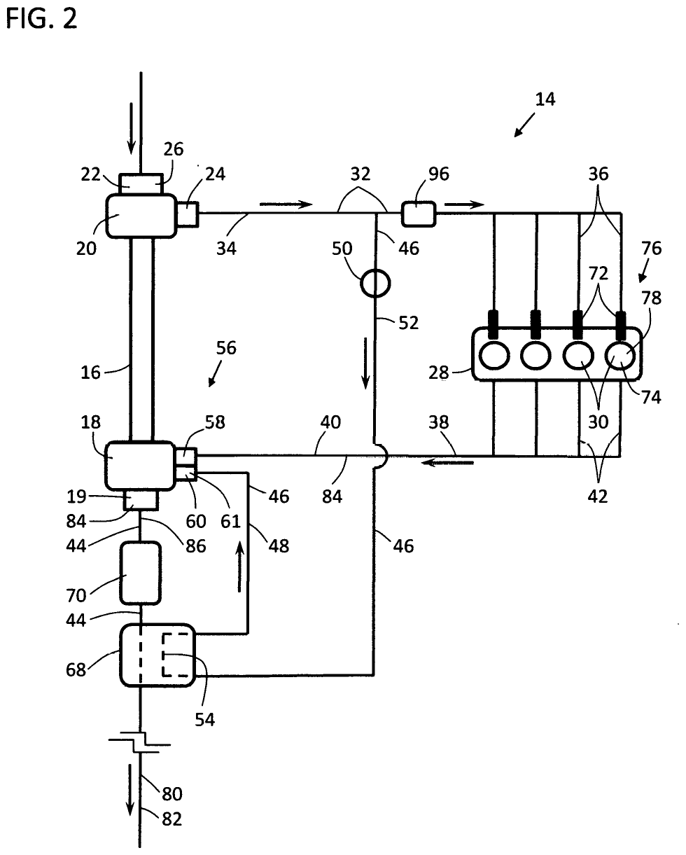

FIG. 1 is intended to diagrammatically illustrate air flow through a turbocharger compressor according to the present invention, and in more detail FIG. 1 is intended to diagrammatically illustrate a portion of the present invention. Air mass flow is shown on the horizontal axis of the FIG. 1 diagram, and compressor pressure ratio in shown on the vertical axis of the FIG. 1 diagram. Constant efficiency compressor contour lines 2 are plotted in the FIG. 1 diagram, with contour line 4 indicating the area of highest compressor operating efficiency. The surge limit line 6 indicates the maximum pressure ratio that can be achieved by the compressor for a given air mass flow rate. Compressor operating conditions to the left of surge limit line 6 will encounter surge, and are therefore unacceptable. Operating conditions to the right of surge limit line 6 will not encounter surge, and may be used within the operating speed limits of the turbocharger. The maximum speed limit line 8 of the compressor is shown generally above contour lines 2. According to the present invention, Point 10 is intended to indicate air flow and pressure ratio needs for a representational internal combustion engine operating at a low speed and a high brake mean effective pressure ratio. Point 10 is located to the left of surge limit line 6 and will therefore encounter surge. The compressor cannot be operated at point 10 because of surge. Point 12 is intended to indicate air flow and pressure needs for the same representational internal combustion engine plus air flow being directed to a bypass duct. The bypass duct will be described in more detail with reference to FIG. 2. Point 12 shows the combined air mass flow through the engine and the bypass duct. Point 12 is located to the right of surge limit line 6 and will therefore provide stable and acceptable compressor performance according to the present invention.

FIG. 2 is intended to diagrammatically illustrate an extended performance range turbocharging system 14 according to the present invention. Turbocharging system 14 includes a turbocharger 16 having a turbine 18 and a compressor 20, having a compressor inlet 22 and compressor outlet 24. Turbocharging system 14 further includes compressor inlet air 26, compressor inlet air 26 being in compressor inlet 22. Turbocharging system 14 further includes an internal combustion engine 28 having one or more combustion cylinders 30. Turbocharging system 14 further includes and an intake air passageway 32 connecting compressor 20 to internal combustion engine 28, and compressor outlet air 34, compressor outlet air 34 being inside intake air passageway 32. Intake air passageway 32 may have one or more branches or ducts 36 for delivery of compressor outlet air 34 to combustion cylinders 30.

Turbocharging system 14 further includes an upstream exhaust gas passageway 38 connecting internal combustion engine 28 to turbine 18 for providing a flow path from internal combustion engine 28 to turbine 18, and exhaust gas 40, exhaust gas 40 being inside upstream exhaust gas passageway 38. Upstream exhaust gas passageway 38 may have one or more branches or ducts 42 for delivery of exhaust gas 40 from combustion cylinders 30 to turbine 18. Turbine 18 also has a turbine outlet flow passageway 44.

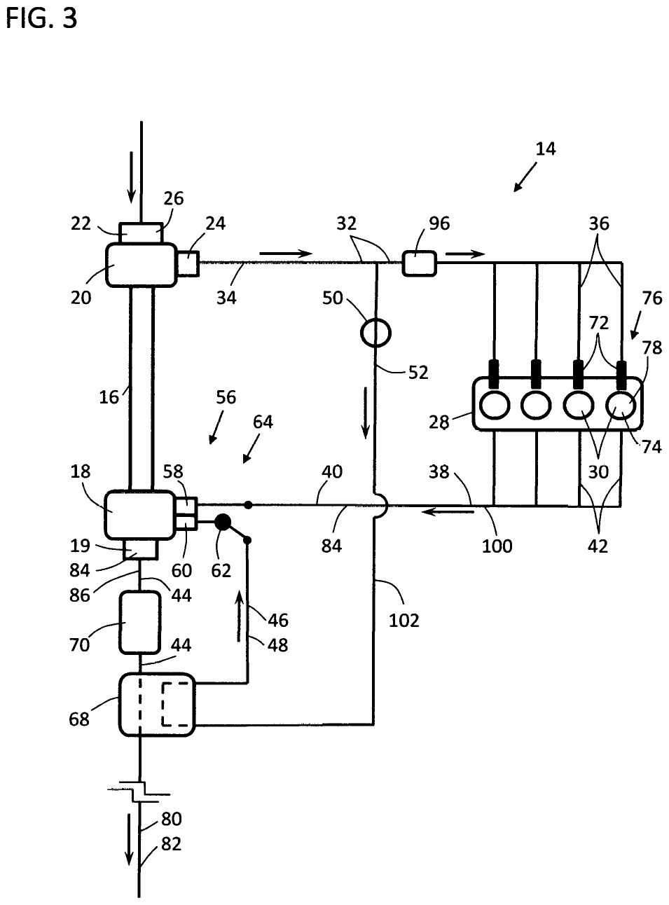

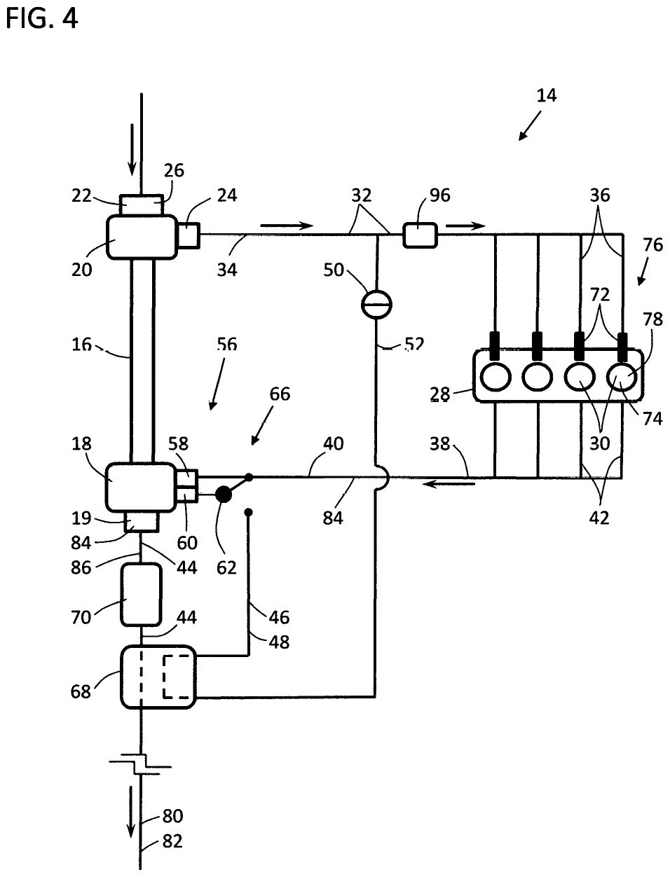

Turbocharging system 14 further includes a bypass air passageway 46 connecting intake air passageway 32 to turbine 18 for providing a flow path from intake air passageway 32 to turbine 18 outside of internal combustion engine 28. Turbocharging system 14 further includes bypass air 48, bypass air 48 being inside bypass air passageway 46. Bypass air passageway 46 also includes a bypass valve 50 located between intake air passageway 32 and turbine 18. Referring now to FIGS. 3 and 4, bypass valve 50 may optionally be integrated into a turbine entry valve 62. Bypass air 48 may optionally include some exhaust gas, for example from exhaust gas recirculation. Bypass air 48 may optionally also include water.

According to the present invention, bypass air passageway 46 further includes a heat exchanger 68 for heating bypass air 48 with the hot exhaust gas of the engine. Heating bypass air 48 upstream of turbine 18 increases turbine power, thereby reducing turbo lag and increasing compressor pressure ratio.

Bypass air passageway 46 has a bypass fuel to air mixture ratio 54 in heat exchanger 68. According to the present invention, the bypass fuel to air mixture ratio 54 is equal to zero in order to prevent combustion of bypass air 48 upstream of exhaust gas passageway 38 for maximizing safety and minimizing system cost.

Preferably, according to the present invention, bypass air 48 and exhaust gas 40 are noncombustible upstream of turbine 18 in order to prevent large explosions from occurring in upstream exhaust gas passageway 38. Combustion of fuel and air in upstream exhaust gas passageway can damage turbocharger 16 and upstream exhaust gas passageway 38.

FIG. 2 shows internal combustion engine 28 having a first turbine inlet setting 56. Upstream exhaust gas passageway 38 and bypass air passageway 46 are separated in first turbine inlet setting 56. Bypass air 48 is separated from exhaust gas 40 so that oxygen from bypass air 48 cannot mix with unburned fuel 84 in exhaust gas 40. Bypass air 48 is separated from unburned fuel 84 to prevent combustion or significant explosions from occurring in upstream exhaust gas passageway 38.

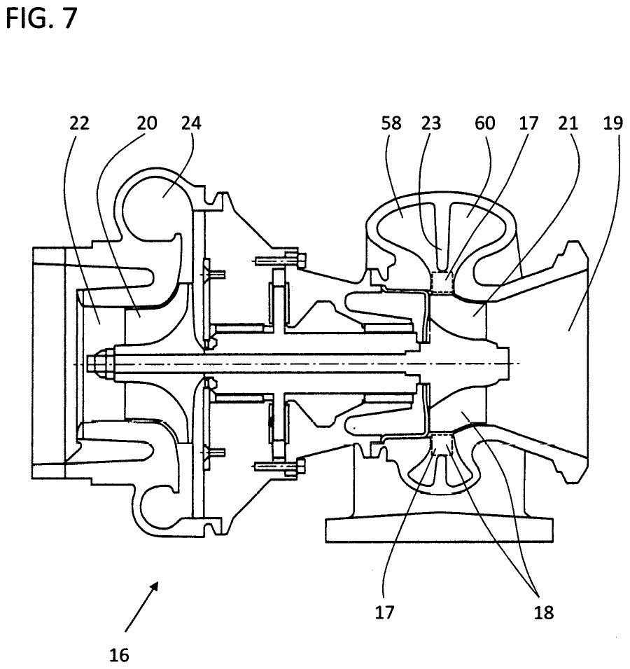

Bypass air 48 is considered separate from unburned fuel 84 provided that any mixing of bypass air 48 with unburned fuel 84 is minor or small. Minor mixing of bypass air and unburned fuel 84 may occur downstream of upstream exhaust gas passageway 38, for example in the turbine inlet clearance volume 17, shown in FIG. 7. This mixing and potential combustion is both minor and occurs downstream of the upstream exhaust gas passageway 38.

FIG. 2 shows turbine 18 having a first scroll or volute 58 for flow of exhaust gas 40 into turbine 18, and bypass air passageway 46 having a second scroll or volute 60 for flow of bypass air 48 into turbine 18. First scroll 58 is separated from second scroll 60 for limiting or preventing mixing of exhaust gas 40 with bypass air 48 upstream of turbine 18, and also to maximizing the blowdown impulse energy of the exhaust gas [symbol] 8.

Referring now to FIG. 7, turbocharger 16 further includes a turbine wheel 21, a turbine inlet clearance volume 17 and a center divider or patrician wall 23 between first scroll 58 and second scroll 60. Turbine inlet clearance volume 17 is the clearance volume between the turbine wheel 21 and the center divider 23. In more detail turbine clearance volume 17 extends outward from the turbine wheel 21 into contact with the center divider 23. Twin scroll turbochargers include a turbine inlet clearance volume 17 as an assembly tolerance and to improve aerodynamic flow into the turbine wheel 21. Turbine clearance volume 17 encircles the turbine wheel inlet and is diagrammatically illustrated with a dashed line in the section view drawing.

For multi or twin scroll turbines, turbine 18 includes the swept volume of the turbine wheel 21 plus the turbine inlet clearance volume 17 between the turbine wheel 21 and the center divider 23. Turbine 18 is being defined to include clearance volume 17 because there is brief contact between exhaust gas 40 and bypass air 48 within clearance volume 17, and this contact should not diminish the scope and validity of the present invention as claimed. In single scroll turbines there is no center divider 23 or clearance volume 17, and in this case turbine 18 includes only the swept volume of turbine wheel 21.

Referring now to FIG. 2, in one embodiment of the present invention second scroll 60 is a dedicated scroll 61 for bypass air 48 only.

Referring now to FIGS. 3 and 4, in another embodiment of the present invention, turbocharging system 14 further includes a turbine entry valve 62.

Turbine entry valve 62 has a first position 64. Bypass air passageway 46 is in fluid communication with second scroll 60 in first position 64 for flow of bypass air 48 into turbine 18 through second scroll 60. First position 64 is generally used for providing high boost pressure from turbocharger 16 at low engine speeds.

Turbine entry valve 62 has a second position 66. Bypass air passageway 46 is closed to second scroll 60 in second position 66, and exhaust gas 40 is in fluid communication with first scroll 58 and second scroll 60. Second position 66 is generally used for providing high boost pressures from turbocharger 16 at higher engine speeds. First position 64 combined with second position 66 provides a turbocharging system able to deliver high boost pressures over a wide range of engine speeds.

In more detail, turbine entry valve 62 has a first position 64. Bypass air passageway 46 is in fluid communication with second scroll 60 in first position 64 for flow of bypass air 48 into turbine 18 through second scroll 60, and for flow of exhaust gas 40 into first scroll 58. First position 64 is generally used for providing high boost pressure from turbocharger 16 at low engine speeds. Turbine entry valve 62 has a second position 66. Upstream exhaust gas passageway 38 is in fluid communication with first scroll 58 and second scroll 60 in second position 66 for flow of exhaust gas 40 into first scroll 58 and second scroll [symbol] is generally used [symbol] oviding high boost pressures from turbocharger 16 at high engine speeds. First position 64 combined with second position 66 provides a turbocharging system able to deliver high boost pressures over a wide range of engine speeds.

Referring now to FIG. 3, bypass valve 50 has an open position in first position 64 for flow of bypass air 48 into turbine 18 through turbine entry valve 62. Bypass valve 50 may optionally regulate flow of bypass air 48 into turbine 18. Bypass valve 50 may provide superior flow rate control of bypass air 48, and may be located in a cool location of bypass air passageway 46 for minimizing cost and maximizing reliability. Bypass valve 50 may optionally not be used. Flow of bypass air 48 into turbine 18 may optionally be controlled directly by turbine entry valve 62. Referring now to FIG. 4, bypass valve 50 is closed in second position 66 for preventing flow of bypass air 48 into turbine 18.

Turbine entry valve 62 is diagrammatically illustrated in FIGS. 3 and 4. Turbine entry valve 62 may be similar in design to a turbocharger waste gate valve, or exhaust flow valves currently used in commercially available engines, or an alternative type of turbine entry valve may be used according to the present invention.

FIGS. 2, 3 and 4 show heat exchanger 68 located in turbine outlet flow passageway 44 for heating of bypass air 48 according to the present invention. Heating of bypass air 48 increasing the power output of turbine 18, and the more powerful turbine reduces turbo lag and increases the compressor pressure ratio, and in more detail increases the boost pressure of compressor outlet air 34.

Optionally bypass air 48 can be heated by a heat exchanger located upstream of turbine 18, that receives heat from the exhaust gas 40 in upstream exhaust gas passageway 38, but preferably heat exchanger 68 is located downstream of turbine 18 for maximizing turbocharger performance.

According to an embodiment of the present invention, a catalytic converter 70 is used for both reducing pollutants and increasing turbocharger performance. Referring now to FIGS. 2, 3 and 4, turbocharging system 14 further includes a catalytic converter 70. Catalytic converter 70 is located in turbine outlet flow passageway 44 upstream of heat exchanger 68. In more detail, heat exchanger 68 is located downstream of catalytic converter 70 in turbine outlet flow passageway 44.

Turbocharging system 14 further including fuel injection 72 and an engine fuel to air ratio 74 in internal combustion engine 28. Turbocharging system 14 further includes a first engine setting 76, first engine setting 76 has a rich engine fuel to air ratio 78. Exhaust gas 40 in upstream exhaust gas passageway 38 includes unburned fuel 84 in first engine setting 76 due to the rich engine fuel to air ratio 78. The unburned fuel 84 combines with bypass air 48 and combusts upstream of heat exchanger 68, thereby increasing the temperature of the heat exchanger and in turn bypass air 48. Heating of bypass air 48 increasing the power output of turbine 18, and the more powerful turbine reduces turbo lag and increases the boost pre [symbol] tlet air 34.

Catalytic converter 70 enhances or accelerates combustion of unburned fuel 84 and bypass air 48 in a process referred to as catalytic combustion. Catalytic combustion increases the temperature of heat exchanger 68 and bypass air 48 according to the present invention, thereby increasing turbine power and compressor boost pressure.

Internal combustion engine 28 has a tailpipe 80 and exhaust pollutants 82 in tailpipe 80 from combustion of fuel in internal combustion engine 28. Turbine 18 has a turbine outlet 19 having unburned fuel 84 from combustion of the rich engine fuel to air ratio 78 in combustion cylinders 30. According to an embodiment of the present invention, catalytic converter 70 has an optimal catalytic converter inlet fuel to air ratio 86 for minimizing exhaust pollutants 82, and rich engine fuel to air ratio 78 is richer than optimal catalytic converter inlet fuel to air ratio 86. Turbine outlet 19 includes rich engine fuel to air ratio 78, and according to the present invention addition of bypass air 48 provides optimal catalytic converter inlet fuel to air ratio 86 for minimizing exhaust pollutants 82, thereby increasing the temperature of bypass air 48 upstream of turbine 18 for increasing the performance range of turbocharger 16 and thereby minimizing exhaust pollutants.

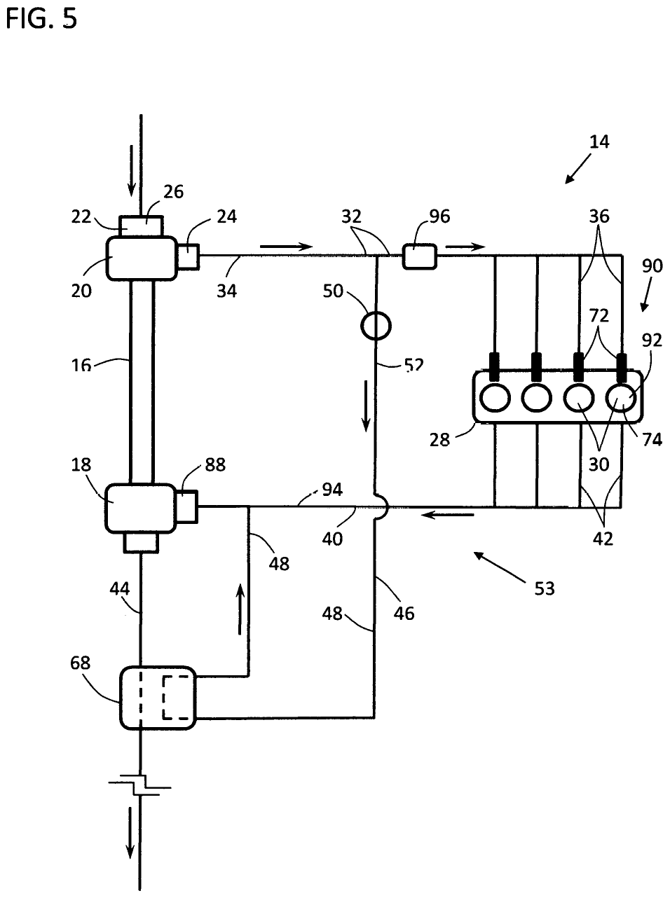

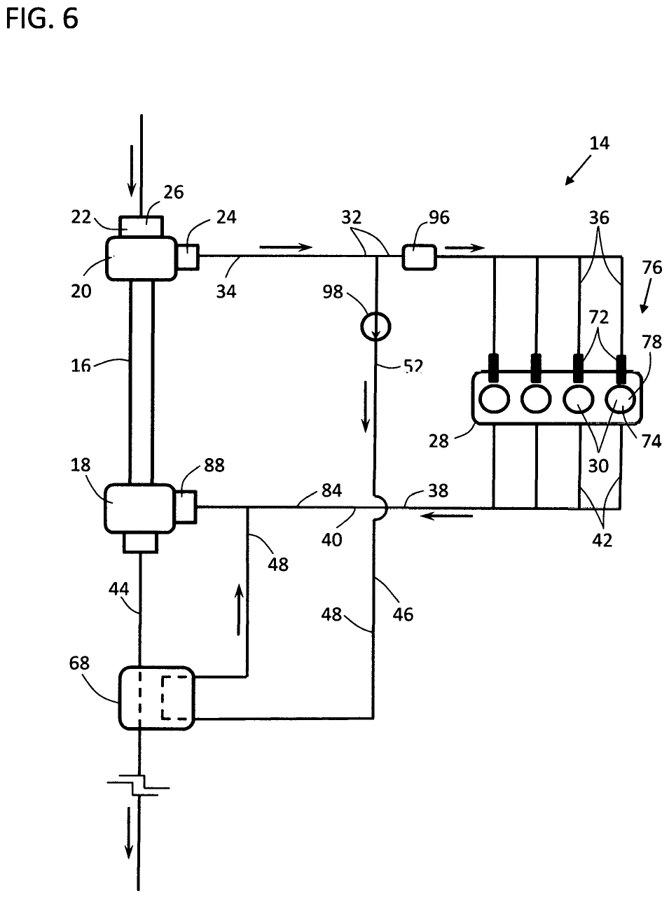

Referring now to FIG. 5 according to an embodiment of the present invention bypass air passageway 46 includes heat exchanger 68. Heat exchanger 68 is located in turbine outlet flow passageway 44 for heating of bypass air 48. Heating of bypass air 48 increasing the power output of turbine 18, and the more powerful turbine reduces turbo lag and increases the boost pressure of compressor outlet air 34. Internal combustion engine 28 further includes fuel injection 72 and internal combustion engine 28 has an engine fuel to air ratio 74. Turbocharging system 14 has a second engine setting 90 according to the present invention. Second engine setting 90 has a lean engine fuel to air ratio 92. Lean engine fuel to air ratio 92 may be used for a compression ignition diesel engine, or for a spark ignition engine, or for an engine having an alternative method of ignition. Exhaust gas 40 has a second fuel to air mixture ratio 94 for second engine setting 90, second fuel to air mixture ratio 94 effectively being zero. In more detail effectively all of the fuel is combusted in internal combustion engine 28 due to the excess air of lean fuel to air ratio 92, and accordingly the fuel to air mixture ratio of exhaust gas 40 is zero. Exhaust gas 40 having no fuel content combines with bypass air 48 upstream of single turbine inlet scroll 88, bypass air 48 also having no fuel content. Bypass valve 50 is used for control of bypass air into turbine 18. Optionally the regulator 98 shown in FIG. 6 may be used instead of bypass valve 50. Optionally turbine 18 has a single turbine inlet scroll 88 and a bypass valve 50 for control of bypass air into single turbine inlet scroll 88. A twin or multi scroll turbine may also be used according to the present invention.

According to the preferred embodiment of the present invention, heat exchanger 68 is located in turbine outlet flow passageway 44 for heating of bypass air 48. Heating of bypass air 48 increasing the power output of turbine 18, and the more powerful turbine reduces turbo lag and increases the compressor pressure ratio and the boost press [symbol] t air 34. Additiona [symbol] pstream exhaust gas passageway 38 further includes a first scroll 58 for flow of exhaust gas 40 into turbine 18, and bypass air passageway 46 further includes a second scroll 60 for flow of bypass air 48 into turbine 18, first scroll 58 being separated from second scroll 60 for limiting mixing of exhaust gas 40 with bypass air 48 upstream of turbine 18, for maximizing the blowdown impulse energy of the exhaust gas flowing into turbine 18. According to one embodiment of the present invention, second scroll 60 is a dedicated scroll 61 for bypass air 48 only. According to another embodiment of the present invention, turbocharging system 14 further includes a turbine entry valve 62. Turbine entry valve 62 has a first position 64. Bypass air passageway 46 is in fluid communication with second scroll 60 in first position 64 for flow of bypass air 48 into turbine 18 through second scroll 60. First positon 64 is generally used for providing high boost pressure from turbocharger 16 at low engine speeds. Turbine entry valve 62 has a second position 66. Bypass air passageway 46 is closed to second scroll 60 in second position 66, and exhaust gas 40 is in fluid communication with first scroll 58 and second scroll 60. Second position 66 is generally used for providing high boost pressures from turbocharger 16 at higher engine speeds. First position 64 combined with second position 66 provides a turbocharging system able to deliver high boost pressures over a wide range of engine speeds. In more detail, turbine entry valve 62 has a first position 64. Bypass air passageway 46 is in fluid communication with second scroll 60 in first position 64 for flow of bypass air 48 into turbine 18 through second scroll 60, and for flow of exhaust gas 40 into first scroll 58. First position 64 is generally used for providing high boost pressure from turbocharger 16 at low engine speeds. Turbine entry valve 62 has a second position 66. Upstream exhaust gas passageway 38 is in fluid communication with first scroll 58 and second scroll 60 in second position 66 for flow of exhaust gas 40 into first scroll 58 and second scroll 60. Second position 66 is generally used for providing high boost pressures from turbocharger 16 at higher engine speeds. First position 64 combined with second position 66 provides a turbocharging system able to deliver high boost pressures over a wide range of engine speeds.

Referring now to FIG. 6, according to another embodiment of the present invention, heat exchanger 68 is located in turbine outlet flow passageway 44 for heating of bypass air 48, and internal combustion engine 28 includes fuel injection 72 and an engine fuel to air ratio 74. Internal combustion engine 28 further includes a first engine setting 76, first engine setting 76 having a rich engine fuel to air ratio 78, and unburned fuel 84, unburned fuel 84 being in exhaust gas 40. Unburned fuel 84 and bypass air 48 combine and combust or partially combust upstream of turbine 18, thereby reducing turbo lag and increasing boost pressure. Heating of bypass air 48 in heat exchanger 68 reduces the amount of fuel needing to be burned upstream of turbine 18 for providing high boost pressures and reduced turbo lag. According to the present invention, heating of the bypass air in heat exchanger 68 enables the amount of combustion taking place in upstream exhaust gas passageway 38 to be small enough so as [symbol] 18 or upstream [symbol] ust gas passageway 38. Heat exchanger 68 may optionally be located upstream of turbine 18, and in more detail heat exchanger 18 may draw heat from exhaust gas 40 upstream of turbine 18. In some embodiments of the present invention, bypass air passageway 46 further including a regulator 98 for preventing backflow of bypass air 48 in bypass air passageway 46. Regulator 98 may be a check valve, a rotating valve, a positive displacement regulator such as a positive displacement pump, a roots blower, a poppet valve, or another functional regulator for preventing backflow of air in bypass air passageway 46. Regulator 98 may be driven by an electric motor for regulating the flow rate of bypass air 48.

Referring now to FIGS. 2 through 5, according to another embodiment of the present invention bypass air passageway 46 further has an extended flow period 52 for providing bypass air 48 to turbine 18 over an extended period of time. The extended flow period 52 is preferably greater than or at least twenty seconds for minimizing turbo lag and providing high boost pressure at low engine speeds. Referring now to FIG. 5, the extended flow period may be much longer, for example in long haul diesel truck engines. A sustained load extended flow period 53 is preferably at least 2 minutes long, and in some cases may last for over ten minutes. The sustained flow can improve diesel engine fuel economy under some driving conditions. Flow may be controlled by a constant flow valve, by a pulse width modulated valve, or by other means. According to the present invention, the average flow rate will be considered for pulse width modulated flow and other modulated flow control systems when calculating the extended flow period. Using the average flow rate is necessary for valves that turn on and off many times to control flow, because these systems could be inaccurately assumed to have a very short flow period. The flow rate of bypass air 48 may be controlled with bypass valve 50 or regulator 98.

Referring now to FIGS. 2 through 6, preferably turbocharging system 14 includes an intercooler or after cooler 96 for cooling compressor outlet air 34. Preferably bypass air passageway 46 receives compressor outlet air 34 upstream of intercooler 96. Bypass air 48 is drawn from upstream of intercooler 96 in order to maximize the temperature of bypass air 48 for maximizing the power output of turbine 18.

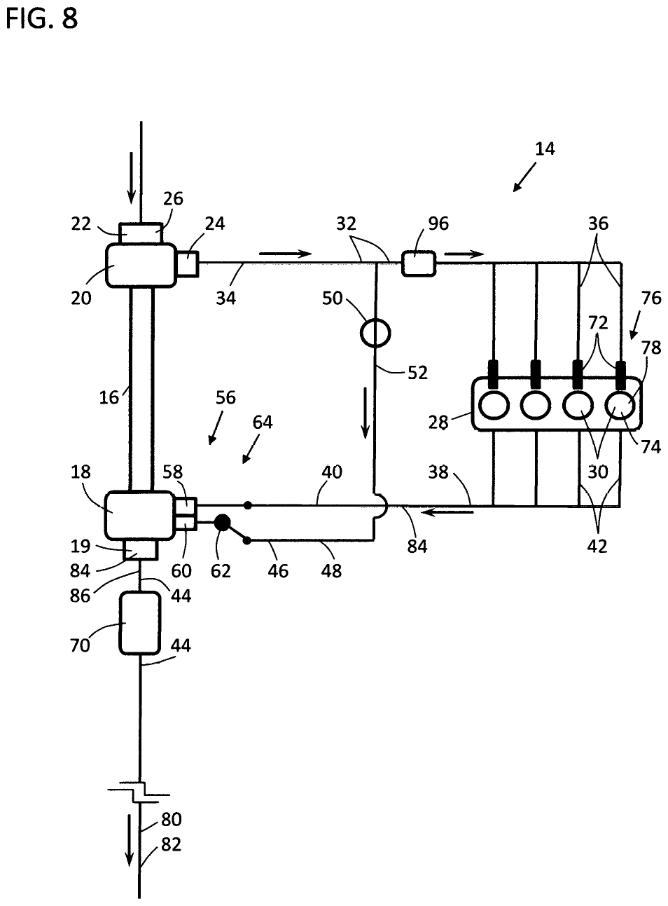

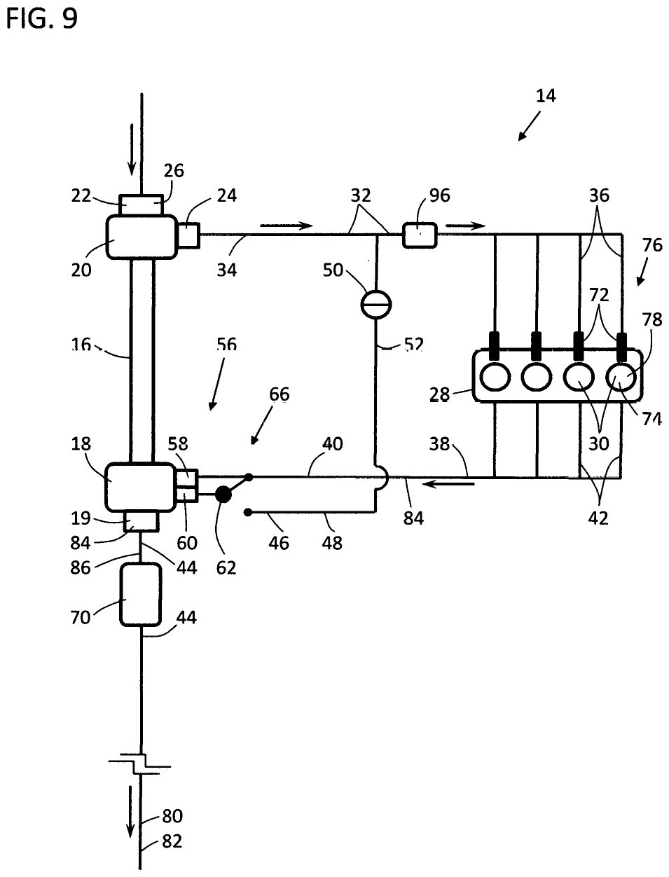

Referring now to FIGS. 8 and 9, the cost of turbocharging system 14 can be minimized by eliminating heat exchanger 68. According to an embodiment of the present invention, turbocharging system 14 for an internal combustion engine 28 includes a turbocharger 16 having a compressor 20, having a compressor outlet 24 and an intake air passageway 32 connecting compressor outlet 24 to internal combustion engine 28, and compressor outlet air 34, compressor outlet air 34 being in intake air passageway 32. Turbocharger 16 further including a turbine 18, and turbine 18 has a turbine outlet flow passageway 44. Turbocharging system 14 has an upstream exhaust gas passageway 38 connecting internal combustion engine 28 to turbine 18 for providing a flow path from internal combustion engine 28 to turbine 18. Exhaust [symbol] passageway 38. T [symbol] arging system 14 further includes a bypass air passageway 46 connecting intake air passageway 32 to turbine 18 for providing a flow path from intake air passageway 32 to turbine 18 outside of internal combustion engine 28, and bypass air 48, bypass air 48 being in bypass air passageway 46. According to the present invention, upstream exhaust gas passageway 38 further includes a first scroll 58 for flow of exhaust gas 40 into turbine 18, and bypass air passageway 46 further includes a second scroll 60 for flow of bypass air 48 into turbine 18. First scroll 58 is separated from second scroll 60 for limiting mixing of exhaust gas 40 with bypass air 48 upstream of turbine 18, for maximizing the blowdown impulse energy of the exhaust gas flowing into turbine 18.

A bypass valve 50 is optionally used for control of bypass air into second scroll 60. Second scroll 60 may optionally be a dedicated scroll 61 for bypass air 48 only as shown in FIG. 2.

Referring again to FIGS. 8 and 9, turbocharging system 14 may optionally include a turbine entry valve 62. Turbine entry valve 62 has a first position 64. Bypass air passageway 46 is in fluid communication with second scroll 60 in first position 64 for flow of bypass air 48 into turbine 18 through second scroll 60, and for flow of exhaust gas 40 into first scroll 58. Turbine entry valve 62 has a second position 66. Upstream exhaust gas passageway 38 is in fluid communication with first scroll 58 and second scroll 60 in second position 66 for flow of exhaust gas 40 into first scroll 58 and second scroll 60. First position 64 is generally used for providing high boost pressure from turbocharger 16 at low engine speeds. Second position 66 is generally used for providing high boost pressures from turbocharger 16 at higher engine speeds. First position 64 combined with second position 66 provides a turbocharging system able to deliver high boost pressures over a wide range of engine speeds. Elimination of heat exchanger 68 enables system cost to be minimized.

Referring now to FIGS. 1 and 3, exhaust gas passageway 38 has an exhaust gas mass flow rate 100, and bypass air passageway 46 has a bypass air mass flow rate 102. Preferably, according to the present invention the ratio of bypass air mass flow rate 102 to exhaust gas mass flow rate 100 is at least 0.12, for providing needed air for reducing hydrocarbon emissions in catalytic converter 70, thereby providing low tailpipe emissions and increased boost pressure from turbocharger 16.

Bypass air flow can be increased for further increasing turbocharger boost pressure and engine brake mean effective pressure at low engine speeds. A ratio of bypass air mass flow rate 102 to exhaust gas mass flow rate 100 of at least 0.25 provides maximum boost pressure from turbocharger 16 at low engine speed.

1. An extended performance range turbocharging system, including a turbocharger 16 having a compressor 20, having a compressor outlet 24, an internal combustion engine 28 and an intake air passageway 32 connecting compressor outlet 24 to internal combustion engine 28, and compressor outlet air 34, compressor outlet air 34 being in intake air passageway 32,
turbocharger 16 further including a turbine 18, turbine 18 further having a turbine outlet flow passageway 44,
and an upstream exhaust gas passageway 38 connecting internal combustion engine 28 to turbine 18 for providing a flow path from internal combustion engine 28 to turbine 18, and exhaust gas 40, exhaust gas 40 being in upstream exhaust gas passageway 38,
and a bypass air passageway 46, connecting intake air passageway 32 to turbine 18 for providing a flow path from intake air passageway 32 to turbine 18 outside of internal combustion engine 28, and bypass air 48, bypass air 48 being in bypass air passageway 46,
wherein bypass air passageway 46 further including a heat exchanger 68, thereby increasing turbine power, reducing turbo lag and increasing compressor pressure ratio.

2. The extended performance range turbocharging system of claim 1, including bypass air 48 and exhaust gas 40 upstream of turbine 18,
bypass air 48 and exhaust gas 40 further being noncombustible upstream of turbine 18.

3. The extended performance range turbocharging system of claim 1, wherein internal combustion engine 28 has a first turbine inlet setting 56, upstream exhaust gas passageway 38 and bypass air passageway 46 being separated in first turbine inlet setting 56,
bypass air 48 and exhaust gas 40 thereby being noncombustible upstream of turbine 18.

4. The extended performance range turbocharging system of claim 1, wherein upstream exhaust gas passageway 38 further includes a first scroll 58 for flow of exhaust gas 40 into turbine 18, and bypass air passageway 46 further includes a second scroll 60 for flow of bypass air 48 into turbine 18, first scroll 58 being separated from second scroll 60 for limiting mixing of exhaust gas 40 with bypass air 48 upstream of turbine 18, for maximizing the blowdown impulse energy of the exhaust gas flowing into turbine 18.

5. The extended performance range turbocharging system of claim 4, further including a bypass valve 50 for control of bypass air into second scroll 60,
wherein second scroll 60 is a dedicated scroll 61 for bypass air 48 only.

6. (canceled)

7. The extended performance range turbocharging system of claim 1, heat exchanger 68 further being in turbine outlet flow passageway 44 for heating of bypass air 48, thereby increasing turbine power, reducing turbo lag and increasing compressor pressure ratio.

8. The extended performance range turbocharging system of claim 7, further including a catalytic converter 70, catalytic converter 70 being located in turbine outlet flow passageway 44, wherein heat exchanger 68 is located downstream of catalytic converter 70 in turbine outlet flow passageway 44.

9. The extended performance range turbocharging system of claim 8, further including fuel injection 72 and an engine fuel to air ratio 74 in internal combustion engine 28,
and a first engine setting 76, first engine setting 76 having a rich engine fuel to air ratio 78 for catalytic combustion of bypass air 48 in catalytic converter 70, thereby increasing the temperature of heat exchanger 68 and thereby increasing the temperature of bypass air 48 upstream of turbine 18 for increasing the performance range of turbocharger 16.

10. The extended performance range turbocharging system of claim 9, further having a tailpipe 80 and exhaust pollutants 82 in tailpipe 80 from combustion of fuel in internal combustion engine 28,
turbine outlet 19 further having unburned fuel 84 from combustion of the rich engine fuel to air ratio 78 in combustion cylinders 30,
wherein catalytic converter 70 has an optimal catalytic converter inlet fuel to air ratio 86 for minimizing exhaust pollutants 82, rich engine fuel to air ratio 78 being richer than optimal catalytic converter inlet fuel to air ratio 86,
wherein turbine outlet 19 includes rich engine fuel to air ratio 78, and bypass air 48 provides optimal catalytic converter inlet fuel to air ratio 86 for minimizing exhaust pollutants 82, thereby increasing the temperature of bypass air 48 upstream of turbine 18 for increasing the performance range of turbocharger 16 and thereby minimizing exhaust pollutants.

11. The extended performance range turbocharging system of claim 7, further including fuel injection 72 and an engine fuel to air ratio 74 in internal combustion engine 28,
and a second engine setting 90, second engine setting 90 having a lean engine fuel to air ratio 92.

12. The extended performance range turbocharging system of claim 11, wherein turbine 18 has a single turbine inlet scroll 88 and a bypass valve 50 for control of bypass air into single turbine inlet scroll 88.

13. The extended performance range turbocharging system of claim 7, wherein upstream exhaust gas passageway 38 further includes a first scroll 58 for flow of exhaust gas 40 into turbine 18, and bypass air passageway 46 further includes a second scroll 60 for flow of bypass air 48 into turbine 18, first scroll 58 being separated from second scroll 60 for limiting mixing of exhaust gas 40 with bypass air 48 upstream of turbine 18, for maximizing the blowdown impulse energy of the exhaust gas flowing into turbine 18.

14. The extended performance range turbocharging system of claim 13, further including a bypass valve 50 for control of bypass air into second scroll 60,
wherein second scroll 60 is a dedicated scroll 61 for bypass air 48 only.

15. (canceled)

16. The extended performance range turbocharging system of claim 7, further including fuel injection 72 and an engine fuel to air ratio 74 in internal combustion engine 28,
and a first engine setting 76, first engine setting 76 having a rich engine fuel to air ratio 78, and unburned fuel 84, unburned fuel 84 being in exhaust gas 40,
unburned fuel 84 and bypass air 48 being combined upstream of turbine 18, thereby providing a combustible mixture upstream of turbine 18 for reducing turbo lag and increasing boost pressure.

17. The extended performance range turbocharging system of claim 7, further including a regulator 98, thereby preventing backflow of bypass air in bypass air passageway 46.

18. The extended performance range turbocharging system of claim 1, further including fuel injection 72 and an engine fuel to air ratio 74 in internal combustion engine 28,
and a first engine setting 76, first engine setting 76 having a rich engine fuel to air ratio 78, and unburned fuel 84, unburned fuel 84 being in exhaust gas 40,
unburned fuel 84 and bypass air 48 being combined upstream of turbine 18, thereby providing a combustible mixture upstream of turbine 18 for reducing turbo lag and increasing boost pressure.

19. The extended performance range turbocharging system of claim 1, wherein bypass air passageway 46 further has an extended flow period 52 for providing bypass air 48 to turbine 18 over an extended period of time, for providing an extended turbocharger performance range.

20. The extended performance range turbocharging system of claim 19, wherein the extended flow period 52 is at least twenty seconds,
thereby providing high boost pressure over a sustained period of time.

21. (canceled)

22. An extended performance range turbocharging system, including a turbocharger 16 having a compressor 20, having a compressor outlet 24, an internal combustion engine 28 and an intake air passageway 32 connecting compressor outlet 24 to internal combustion engine 28, and compressor outlet air 34, compressor outlet air 34 being in intake air passageway 32,
turbocharger 16 further including a turbine 18, turbine 18 further having a turbine outlet flow passageway 44,
and an upstream exhaust gas passageway 38 connecting internal combustion engine 28 to turbine 18 for providing a flow path from internal combustion engine 28 to turbine 18, and exhaust gas 40, exhaust gas 40 being in upstream exhaust gas passageway 38,
and a bypass air passageway 46, connecting intake air passageway 32 to turbine 18 for providing a flow path from intake air passageway 32 to turbine 18 outside of internal combustion engine 28, and bypass air 48, bypass air 48 being in bypass air passageway 46,
wherein upstream exhaust gas passageway 38 further includes a first scroll 58 for flow of exhaust gas 40 into turbine 18, and bypass air passageway 46 further includes a second scroll 60 for flow of bypass air 48 into turbine 18, first scroll 58 being separated from second scroll 60 for limiting mixing of exhaust gas 40 with bypass air 48 upstream of turbine 18, for maximizing the blowdown impulse energy of the exhaust gas flowing into turbine 18.

23. The extended performance range turbocharging system of claim 22, further including a bypass valve 50 for control of bypass air into second scroll 60,
wherein second scroll 60 is a dedicated scroll 61 for bypass air 48 only.

24. The extended performance range turbocharging system of claim 23, further including a turbine entry valve 62,
turbine entry valve 62 further having a first position 64, bypass air passageway 46 being in fluid communication with second scroll 60 in first position 64 for flow of bypass air 48 into turbine 18 through second scroll 60, and for flow of exhaust gas 40 into first scroll 58,
turbine entry valve 62 further having a second position 66, upstream exhaust gas passageway 38 being in fluid communication with first scroll 58 and second scroll 60 in second position 66 for flow of exhaust gas 40 into first scroll 58 and second scroll 60,
thereby providing an extended turbocharger performance range.

25. (canceled)

26. (canceled)
